(19) United States
(12) Patent Application Publication
(10) Pub. No.: US 2008/0149426 A1
(43) Pub. Date: Jun. 26, 2008

(54) ELEVATOR WITH TWO ELEVATOR CARS DISPOSED ONE ABOVE THE OTHER IN A SHAFT

(76) Inventor: Hans Kocher, Udligenswil (CH)

Correspondence Address: FRASER CLEMENS MARTIN & MILLER LLC, 28366 KENSINGTON LANE, PERRYSBURG, OH, 43551, US

(21) Appl. No.: 11/962,659

(22) Filed: Dec. 21, 2007

Related U.S. Application Data
(60) Provisional application No. 60/871,517, filed on Dec. 22, 2006.

(30) Foreign Application Priority Data
Dec. 21, 2006 (EP) 06126795.1

(51) Int. Cl. B66B 9/00

(52) U.S. Cl. 187/249

(57) ABSTRACT

An elevator includes at least two elevator cars which are disposed one above the other and vertically movable in a shaft independently of one another and which each have an associated drive with at least one motor and at least one drive pulley, an associated counterweight and at least one associated tension device. One of the drives is fixed to a first shaft wall and the other drive is fixed to an opposite second shaft wall. The drives can be passed by the elevator cars, wherein the drives are arranged vertically above the associated drive pulleys.

### CROSS-REFERENCE TO RELATED APPLICATION

This application claims the benefit of U.S. provisional patent application Ser. No. 60/871,517 filed Dec. 22, 2006.

### FIELD OF THE INVENTION

The present invention relates to an elevator with at least two elevator cars which are arranged one above the other and vertically movable in a shaft.

### BACKGROUND OF THE INVENTION

An elevator usually comprises an elevator car, which is vertically movable in a shaft and receives passengers in order to transport these to a desired floor of a building. In order to be able to look after this task the elevator usually has at least the following elevator components: a drive with a motor and a drive pulley, deflecting rollers, tension means, a counterweight, as well as a respective pair of guide rails for guidance of the elevator car and the counterweight.

In that case the motor produces the power required for transport of the passengers present in the elevator car. An electric motor usually provides this function. The motor directly or indirectly drives the drive pulley, which is in friction contact with the tension means. The tension means can be a belt or a cable. It serves for suspension as well as conveying the elevator car and the counterweight, which both are so suspended that the gravitational forces thereof act in opposite direction along the tension means. The resultant gravitational force which has to be overcome by the drive, correspondingly substantially reduces. In addition, due to the greater contact force of the tension means with the drive pulley a greater drive moment can be transmitted by the drive pulley to the tension means. The tension means is guided by deflecting rollers.

The optimum utilization of the shaft volume has ever increasing significance in elevator construction. Particularly in high-rise buildings with a high degree of utilization of the building a management of the passenger traffic as efficiently as possible for a given shaft volume is desired. This objective can be achieved firstly by an optimum space-saving arrangement of the elevator components, which creates space for larger elevator cars, and secondly by elevator concepts which enable vertical movement of several independent elevator cars in one shaft.

An elevator with at least two elevator cars disposed one above the other in the same shaft is known from patent document EP 1 489 033. Each elevator car has its own drive and its own counterweight. The drives are arranged near first and second shaft walls and the counterweights are also respectively suspended below the associated drive at tension means near first or second shaft walls. The axes of the drive pulleys of the drives are disposed perpendicularly to the first and second shaft walls. The two independently movable elevator cars ensure a high conveying performance. The positioning of the drives in the shaft near the first or second walls renders a separate engine room superfluous and enables a space-saving, compact arrangement of the drive elements in the shaft head.

### SUMMARY OF THE INVENTION

The task of the present invention is to further improve the arrangement of elevator components for the vertical movement of several elevator cars in an elevator shaft.

The elevator according to the present invention comprises at least two elevator cars which are disposed one above the other and vertically movable in a shaft independently of one another. The elevator cars each have an associated drive with at least one motor and at least one drive pulley, an associated counterweight and at least one associated tension means. A drive is fixed to a first shaft wall and a further drive is fixed to an opposite second shaft wall. The drives can be moved past by the elevator cars and the motors of the drives are arranged vertically above the associated drive pulleys.

The advantage of this elevator resides in the space-saving arrangement of the drives at the first and second shaft walls. The drives lie in the region of the clear profiles of the counterweight and thus do not occupy any additional space in the shaft head or in the shaft pit. Such an arrangement of the drives is thus particularly space-saving.

Advantageously the drives are positioned alternately on opposite shaft walls at two different shaft heights, wherein the spacing between two drives of elevator cars arranged one above the other advantageously amounts to at least one car height.

The advantage of this elevator installation resides in the flexible and simple positioning of however many drives and the associated elevator cars in the same shaft. In a conventional arrangement of the drives in the shaft head, thereagainst, the number of drives which can be installed is limited by the space available in the shaft head. Equally, a guidance of the tension elements free of conflict in such a conventional arrangement of the drives in the shaft head is subject to close limits.

Advantageously the axes of the drive pulleys lie parallel to the first and second shaft wall.

The advantage of this elevator is that the tension means, which are in contact with the drive pulleys, can be guided from the first shaft walls to the second shaft walls directly without horizontal change in direction.

Advantageously the elevator cars are suspended in block-and-tackle manner and have at least two deflecting rollers, which are mounted in the lower region of the elevator cars. Equally advantageously the counterweights are suspended below the associated drives in block-and-tackle manner and the counterweights have third deflecting rollers which are fixed in the upper region of the counterweights.

The advantage of the elevator resides in the 2:1 suspension of the elevator cars and the counterweights. Thanks to this suspension the drive only has to produce half as much drive torque and can be of correspondingly more compact construction and occupy less space in the elevator shaft.

Advantageously the elevator cars are guided by two car guide rails and the counterweights are positionable between car guide rails and first or second shaft walls.

The advantage of this elevator resides in the simple and space-saving arrangement of the counterweights.

Advantageously the tension means consist of at least one cable, double cable or belt. Equally advantageously the load-bearing structure of the tension means is formed from aramide fibers or Vectran (a registered trademark of CNA Holdings, Inc. of Summit, N.J.) fibers.

The advantage of the elevator resides in the use of favorable standard tension means. The use of high-strength synthetic fibers is additionally distinguished, by comparison with traditional steel fibers, by an improved ratio of tensile strength to intrinsic weight.

Advantageously the belts are structured at one side, such as, for example, cogged belts or wedge-ribbed belts structured at one side. Such belts are advantageously guided by the drive pulleys and at least first, second and third deflecting rollers, in which case advantageously only one side of the belt is disposed in contact with the drive pulleys and deflecting rollers. This is due to the fact that the belts are turned through 180° about their respective longitudinal axis between the drive pulleys and the first deflecting rollers.

The advantage of the elevator is that belts structured at one side can be produced as standard and are advantageous. Thanks to the turning through 180° between the drive pulley and the first deflecting roller these belts are always bent in the same sense around the deflecting rollers and drive pulleys. This increases the service life of the belts and reduces the maintenance costs of the elevator.

Advantageously the elevator cars are guided by two car guide rails, wherein these car guide rails form a connecting plane and the tension means, the drive pulleys as well as the first and second deflecting rollers of the associated elevator car are arranged at one side of the connecting plane.

The advantage of the elevator resides in the use of drive pulleys and deflecting rollers with several grooves arranged in parallel. Such drive pulleys and deflecting rollers accept several tension means. Depending on the respective need, several tension means, which are associated with an elevator car, can thus be guided in simple manner parallel adjacent to one another.

Optionally the elevator cars are advantageously guided by two car guide rails, wherein these car guide rails form a connecting plane and the tension means, the drive pulleys as well as the first and second associated deflecting rollers of the associated elevator car are arranged on both sides of the connecting plane.

The advantage of the elevator is the symmetrical suspension at the center of gravity of the elevator cars. Since the car guide rails usually similarly guide the elevator car at the center of gravity of the elevator car, no additional forces and moments are introduced into the car guide rails with such a suspension.

Advantageously each drive is fixed on a crossbeam fastened to the car guide rails and/or to the counterweight guide rails.

The advantage of the elevator according to the present invention is fixing the drives as simply as possible in the shaft space and fully utilizing the structures present.

### DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a schematic side elevation view of an arrangement of an elevator with two elevator cars, two drives, two drive pulleys, two tension means and several deflecting rollers according to the present invention;

FIG. 2 is a schematic plan view of an arrangement of the elevator shown in FIG. 1 wherein the two drives, two drive pulleys, two tension means and several deflecting rollers, lie on opposite sides of a connecting plane formed by two car guide rails;

FIG. 3 is a schematic plan view similar to FIG. 2 wherein the two drives, two drive pulleys, two tension means and several deflecting rollers, lie at the connecting plane formed by the two car guide rails; and

FIG. 4 is a perspective view of an arrangement of the drives on crossbeams in the shaft.

### DESCRIPTION OF THE PREFERRED EMBODIMENT

The U.S. provisional patent application Ser. No. 60/871,517 filed Dec. 22, 2006 is hereby incorporated herein by reference.

The following detailed description and appended drawings describe and illustrate various exemplary embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

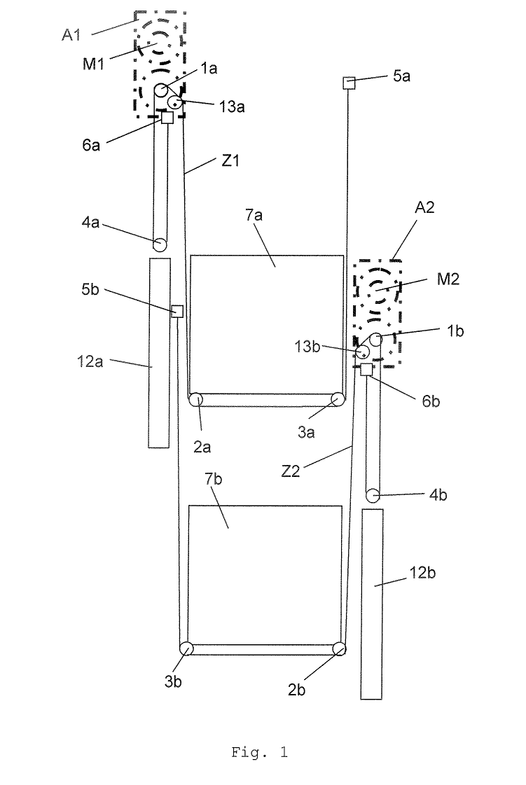

FIG. 1 shows an elevator with at least two elevator cars 7a, 7b, which each have an associated drive A1, A2 and are movable independently of one another in a vertical direction. The drives A1, A2 are positioned laterally at first and second shaft walls. The first and second shaft walls are those mutually opposite shaft walls not having shaft doors. In that case the drives A1, A2 are disposed in alternation on opposite shaft walls at two different shaft heights, wherein as a rule the distance in the vertical direction amounts to at least one car height. The drives A1, A2 define by their position at the same time the highest reachable point of an associated elevator car 7a, 7b, since the tension means in the illustrated form of embodiment cannot raise a suspension point of the elevator car 7a, 7b above the height of an associated drive pulley 1a, 1b respectively. However, it is also conceivable for the two drives A1, A2 of the adjacent elevator cars 7a, 7b to be fixed at the same shaft height.

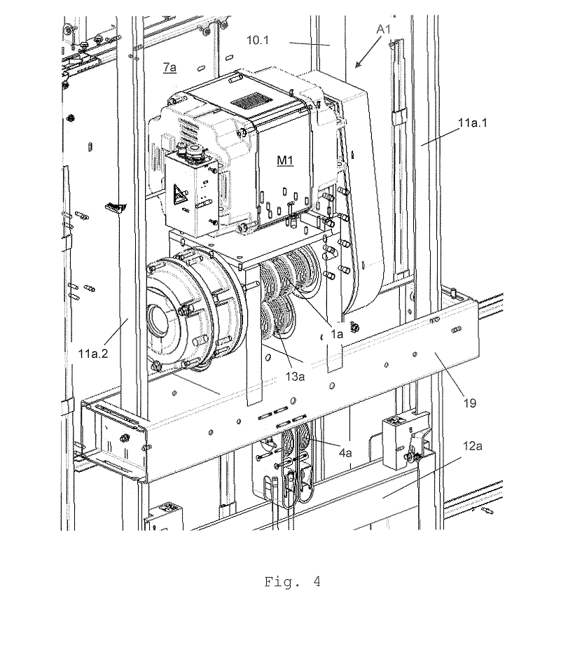

The drive A1, A2 has a motor M1, M2, as shown in FIG. 4, preferably an electric motor, the drive pulley 1a, 1b and optionally a setting pulley 13a, 13b by which the looping angle of a tension means Z1, Z2 around the drive pulley 1a, 1b and the horizontal spacing of the tension means Z1, Z2 from the drive A1, A2, from the elevator car 7a, 7b or from a counterweight 12a, 12b can be set.

The motor M1, M2 lies vertically above the associated drive pulley 1a, 1b. Thanks to this arrangement the drive A1, A2 can be positioned in the clear projection of the counterweights 12a, 12b between the elevator cars 7a, 7b and first and second shaft walls. The drives A1, A2 can thereby be moved past by the elevator cars 7a, 7b and thus can be mounted in an otherwise unneeded space of the shaft. By comparison with conventional elevators without engine rooms space is thereby gained in the shaft head and/or in the shaft pit.

The motor M1, M2 of the drive A1, A2 drives the tension means Z1, Z2 via the drive pulley 1a, 1b. The drive pulley 1a, 1b is so designed that it is suitable for accepting one or several tension means Z1, Z2. The tension means Z1, Z2 are preferably belts such as wedge-ribbed belts with ribs at one side, which engage in one or several depressions at the drive pulley side. Belt variants such as smooth belts and belts which are toothed at one side or both sides are, with corresponding drive pulleys 1a, 1b, similarly usable. In addition, different kinds of cables, such as single cables, double cables or multiple cables, are also usable. The tension means comprise strands of steel wire or aramide or Vectran material.

The at least two elevator cars 7a, 7b and the two counterweights 12a, 12b are suspended at the tension means Z1, Z2 in block-and-tackle manner. In that case the elevator cars have at least one first and second deflecting roller 2a, 2b, 3a, 3b, which are fastened in the lower region of the elevator cars 7a, 7b. These deflecting rollers 2a, 2b, 3a, 3b have at the outer circumference one of several grooves which are such that they can receive one or more of the tension means Z1, Z2. The deflecting rollers 2a, 2b, 3a, 3b are thus suitable for guidance of the tension means Z1, Z2 and are brought into contact with the latter. The elevator cars 7a, 7b are thus preferably suspended as a lower block and tackle.

In an optional form of embodiment the deflecting rollers 2a, 2b, 3a, 3b are disposed in the upper region of the elevator car 7a, 7b. In correspondence with the above description, the elevator car 7a, 7b is suspended as an upper block and tackle.

A third deflecting roller 4a, 4b, which is similarly suitable analogously to the deflecting rollers 2a, 2b, 3a, 3b to receive one or more of the tension means Z1, Z2, is disposed in the upper region of the counterweights 12a, 12b. Correspondingly, the counterweight 12a, 12b is preferably suspended at the third deflecting roller 4a, 4b as an upper block and tackle below the associated drive A1, A2.

The tension means Z1, Z2 is led from a first fixing point 5a, 5b to a second fixing point 6a, 6b via several deflecting rollers 2a, 2b, 3a, 3b, 4a, 4b and the drive pulley 1a, 1b from the first shaft wall to the second shaft wall. The first fixing point 5a, 5b is in that case disposed opposite the associated drive A1, A2 at approximately the same shaft height in the vicinity of a first or second shaft wall. The second fixing point 6a, 6b is disposed in the vicinity of the associated drive A1, A2 on an opposite second or first shaft wall.

From the first fixing point 5a, 5b the tension means Z1, Z2 extends along a first or second shaft wall downwardly to the second deflecting roller 3a, 3b, loops around this from the outside to the inside at an angle of approximately 90° and leads to the first deflecting roller 2a, 2b. The tension means Z1, Z2 loops around this first deflecting roller 2a, 2b from the inside to the outside again through approximately 90° and is thereafter led upwardly along the elevator car 7a, 7b to the drive pulley 1a, 1b and loops around this from the inside to the outside through approximately 150°. Depending on the respective setting of the optional setting pulley 13a, 13b the looping angle can be varied in a range of 90° to 180°. Thereafter, the tension means Z1, Z2 is led along a second or first shaft wall downwardly to the third deflecting roller 4a, 4b, loops around this from the outside to the inside through approximately 180° and is led upwardly back along a second or first shaft wall to the second fixing point 6a, 6b.

The setting pulley 13a, 13b is an optional component of the drive A1, A2. With this setting pulley 13a, 13b the looping angle of the tension means at the drive pulley 1a, 1b can be set, increased or reduced in order to transmit the desired traction forces from the drive pulley 1a, 1b to the tension means Z1, Z2. Depending on the respective spacing of the setting pulley 13a, 13b from the drive pulley 1a, 1b the spacing of the tension means Z1, Z2 from the drive A1, A2, from the counterweight 12a, 12b or from the elevator car 7a, 7b can in addition be set. A conflict-free guidance of the tension means Z1, Z2 in the shaft between the drive pulley 1a, 1b and the first deflecting roller 2a, 2b is thus guaranteed.

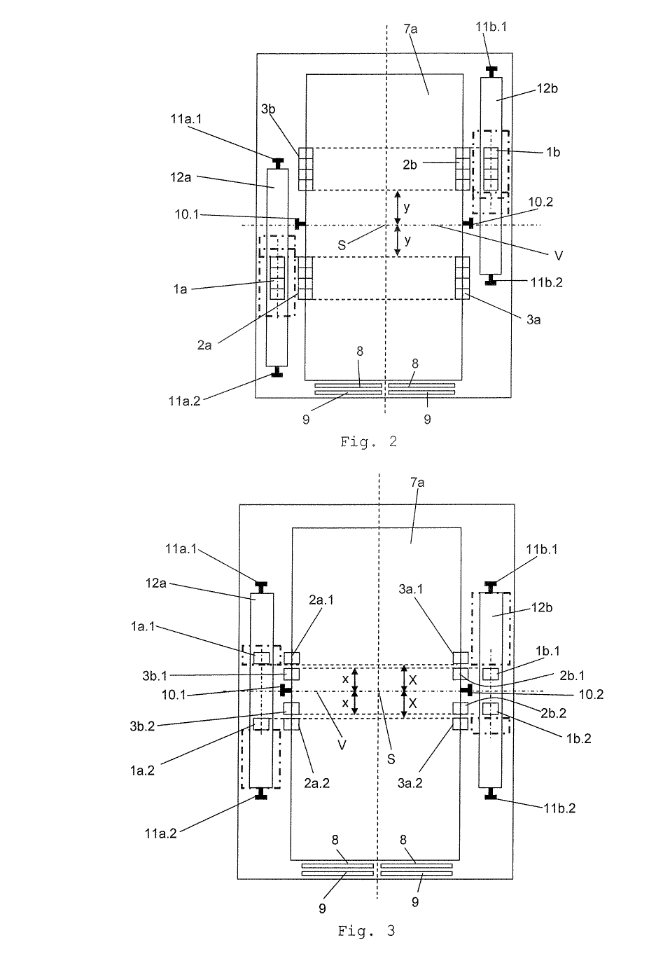

According to FIG. 2 the elevator cars 7a, 7b are guided by two car guide rails 10.1, 10.2. The two car guide rails 10.1, 10.2 form a connecting plane V, which approximately extends through the center of gravity S of each of the two elevator cars 7a, 7b. In the illustrated embodiment the elevator cars 7a, 7b are eccentrically suspended. The tension means Z1, Z2 and the associated drive means, such as the deflecting rollers 2a, 2b, 3a, 3b, 4a, 4b and the drive pulleys 1a, 1b, in this suspension arrangement lie at one side of the connecting plane V, wherein the deflecting rollers 4a, 4b are, for the sake of clarity, not illustrated in FIG. 2, i.e. all afore-mentioned components associated with the elevator car 7a, 7b lie either between third shaft walls and the connecting plane V or between fourth shaft walls and the connecting plane V. Third or fourth shaft walls denote shaft walls which have at least one shaft door 9 and opposite shaft walls. Advantageously a spacing y of the tension means Z1, Z2 and the connecting plane V is approximately the same. The tension means Z1, Z2 of the elevator car 7a, 7b lie in alternation on one or the other side of the connecting plane V. Thus, the moments which are generated by the eccentric suspension of the elevator cars 7a, 7b counteract one another. In the case of an equal rated of load of the elevator cars 7a, 7b and in the case of an even number of elevator cars 7a, 7b, the moments acting on the guide rails 10.1, 10.2 substantially cancel one another.

The counterweights 12a, 12b are each guided by two counterweight guide rails 11a.1, 11a.2, 11b.1, 11b.2. The counterweights 12a, 12b are positioned at opposite shaft walls between the car guide rails 10.1, 10.2 and first or second shaft walls. Advantageously the counterweights are suspended at their center of gravity S at the tension means Z1, Z2. Since the elevator cars 7a, 7b are eccentrically suspended, the counterweights 12a, 12b lie laterally offset in the vicinity of third and fourth shaft walls.

The axes of rotation of the drive pulleys 1a, 1b and the deflecting rollers 2a, 2b, 3a, 3b, 4a, 4b are parallel to first or second shaft walls. In the illustrated embodiment the afore-mentioned components are of the form that they can receive four parallelly extending tension means Z1, Z2, guide these or, in the case of the drive pulley 1a, 1b, also drive these. In order to be able to receive the tension means Z1, Z2 the deflecting rollers 2a, 2b, 3a, 3b, 4a, 4b and the drive pulleys 1a, 1b can have four specially formed contact surfaces, which in the case of cables are designed as, for example, grooves or in the case of belts also as, for example, dished surfaces or toothing or in the case of a flatly constructed contact surface are provided with guide shoulders. These four contact surfaces can be formed either on a common roller-shaped base body or each on four individual rollers with a common axis of rotation.

With knowledge of this embodiment numerous possibilities of variation are open to the expert depending on the respectively set task. Thus, the expert can arrange one to four or more individual rollers with or without a spacing relative to one another on one axis of rotation. In that case each roller can, according to the respective design, receive one to four or, in the case of need, also more tension means Z1, Z2.

In normal operation of the elevator the elevator cars 7a, 7b are, at a floor stop, placed level with respect to the floor and the car doors 8 are opened together with the shaft doors 9 in order to enable transfer of passengers from the floor to the elevator car 7a, 7b and conversely.

FIG. 3 shows an alternative suspension arrangement with centrally suspended elevator cars 7a, 7b. In that case the tension means Z1, Z2 are guided by the deflecting rollers 2a, 2b, 3a, 3b, 4a, 4b and the drive pulleys 1a, 1b at both sides of the connecting plane V. Advantageously, in that case the suspension is arranged symmetrically with respect to the connecting plane V. Since in this case the suspension center of gravity substantially coincides with the center of gravity of the elevator car 7a, 7b, no additional moments act on the car guide rails 10.1, 10.2.

In this central suspension of the elevator cars 7a, 7b the associated deflecting rollers 2a.1, 2a.2, 2b.1, 2b.2, 3a.1, 3a.2, 3b.1, 3b.2 and the drive pulleys 1a.1, 1a.2, 1b.1, 1b.2 consist of at least two rollers, which are arranged on the left and right of the connecting plane V. The deflecting rollers 4a, 4b of the counterweights 12a, 12b similarly consist of two rollers which are arranged on the left and right of the connecting plane V, but for the sake of clarity are not illustrated in FIG. 3. In the present example the deflecting rollers 2a, 3a, 4a and the drive pulley 1a associated with the upper elevator car 7a lie at a first spacing x from the connecting plane V and the deflecting rollers 2b, 3b, 4b and the drive pulley 1b associated with the lower elevator car 7b lie at a second spacing X from the connecting plane V, wherein the first spacing x is smaller than the second spacing X. A conflict-free guidance of the tension means Z1, Z2 is thereby guaranteed in the case of central suspension of the elevator cars 7a, 7b.

Here, too, the counterweights 12a, 12b are advantageously suspended at their center of gravity at the tension means Z1, Z2 between the car guide rails 10.1, 10.2 and the first or second shaft walls. Since the elevator cars 7a, 7b are now centrally suspended, the counterweights 12a, 12b also lie in a middle region of the first and second shaft walls. Thanks to this central position of the counterweights 12a, 12b the free space between the lateral ends of the counterweights 12a, 12b and the third and fourth shaft walls increases. Design freedom for the counterweights 12a, 12b is thereby gained. Thus, for example, a narrower and wider counterweight 12a, 12b can be used in order to better utilize the space. For a given shaft cross-section, the elevator car 7a, 7b gains width or for a given elevator car size the shaft cross-section can be reduced.

FIG. 4 shows the drive A1 which is fixed on a crossbeam 19 fastened to the car guide rail 10.1 and/or to the counterweight guide rails 11a.1, 11a.2. There can also be seen in FIG. 4: the motor M1 with the drive pulley 1a arranged thereunder and the optional setting pulley 13a, the third deflecting roller 4a at which the counterweight 12a is suspended and, in the background, the elevator car 7a. The example shown here is in mirror image by comparison with the arrangement of FIG. 2 with respect to the connecting plane V.

The drives A1, A2 can optionally also be directly fixed to the shaft walls and the crossbeam 19 eliminated.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. An elevator having at least two elevator cars, which cars are disposed one above the other and are vertically movable in a shaft independently of one another and which each have an associated drive with at least one motor and at least one drive pulley, an associated counterweight, and at least one associated tension means, comprising:
a first one of the drives is fixed to a first shaft wall and a second one of the drives is fixed to an opposite second shaft wall and the elevator cars can move past the first and second drives; and
a motor of each of the first and second drives is arranged vertically above the at least one drive pulley.

2. The elevator according to claim 1 wherein the first and second drives are positioned alternately on the opposite first and second shaft walls at two different shaft heights.

3. The elevator according to claim 2 wherein a vertical spacing between the first and second drives is at least a height of one of the elevator cars.

4. The elevator according to claim 1 wherein axes of the at least one drive pulleys lie parallel to the first and second shaft walls.

5. The elevator according to claim 1 wherein the elevator cars are suspended from the associated tension means in a block-and-pulley arrangement.

6. The elevator according to claim 5 wherein the elevator cars each have at least two deflecting rollers mounted in one of an upper region and a lower region of the elevator cars.

7. The elevator according to claim 6 wherein the tension means are guided by the drive pulleys and the deflecting rollers to fixing points of the tension means.

8. The elevator according to claim 1 wherein the counterweights are suspended below the associated drives in a block-and-pulley arrangement.

9. The elevator according to claim 8 wherein the counterweights have deflecting rollers fixed in the upper region of the counterweights.

10. The elevator according to claim 9 wherein the tension means are guided by the drive pulleys and said deflecting rollers to fixing points of the tension means.

11. The elevator according to claim 10 wherein the counterweights are each guided for movement in the shaft by two counterweight guide rails.

12. The elevator according to claim 1 wherein the elevator cars are guided by two car guide rails and the counterweights are positioned between the car guide rails and adjacent shaft walls.

13. The elevator according to claim 1 wherein the tension means is at least one cable, a double cable, or at least one belt.

14. The Elevator according to claim 13 wherein a supporting structure of the tension means is formed from aramide or Vectran fibers.

15. The elevator according to claim 13 wherein said at least one belt is structured at one side.

16. The elevator according to claim 13 wherein said at least one belt is a cogged belt or a wedge-ribbed belt.

17. The elevator according to claim 13 said at least one belt is guided by the drive pulley and at least first, second and third deflecting rollers, only one side of said at least one belt being in contact with the drive pulley and said deflecting rollers and said at least one belt is turned through 180° about a longitudinal axis between the drive pulley and said first deflecting roller.

18. The elevator according to claim 1 wherein the elevator cars are guided by two car guide rails forming a connecting plane and the tension means, the drive pulleys, as well as first and second deflecting rollers of the associated elevator car are arranged at one side of the connecting plane.

19. The elevator according to claim 1 wherein the elevator cars are guided by two car guide rails forming a connecting plane and the tension means, the drive pulleys, as well as first and second deflecting rollers of the associated elevator car are arranged on both sides of the connecting plane.

20. The elevator according to claim 1 wherein each of the drives is fixed on a crossbeam fastened to car guide rails or counterweight guide rails.
